(19) United States
(12) Patent Application Publication
(10) Pub. No.: US 2008/0273126 A1
(43) Pub. Date: Nov. 6, 2008

(54) Digital photo frame apparatus

(76) Inventor: Yu-Tsung Chang, Miao-Lih Hsuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,955

(22) Filed: Sep. 7, 2007

(30) Foreign Application Priority Data
May 4, 2007 (TW) 096207203

(51) Int. Cl. H04N 5/64; H04N 9/12

(52) U.S. Cl. 348/836; 348/739; 348/E09.012; 348/E05.128

(57) ABSTRACT

A digital photo frame apparatus comprises at least one memory card slot, at least one transmission interface port, a power supply device, a signal processing controller, a display device, a display driver module and an input control module. The memory card slot is for connecting to a memory card to read digital image data in a memory card, and the signal processing controller is for processing inputted digital image data and controlling its playback method, and the display device and the display driver module are for displaying digital images. The input control module is for controlling an input device which is connected to a port, such as a keyboard, a mouse or a microphone, so that a user can use the input device to input data to a digital image for adding or recording text data, graphic data or audio data to the digital image.

### BACKGROUND OF THE INVENTION

1. Field of the Invention

The present invention relates to a digital photo frame apparatus, and more particularly to a technical field of the digital photo frame apparatus capable of connecting an input device directly for editing digital image.

2. Description of the Related Art

In general, a photo frame is used for protecting photos and showing decorative displays, but only can hold a certain number of photos. Furthermore, the photos will be faded after a period of time due to the development chemicals of the photos, and thus there is a time limitation for the storage. As digital image devices become increasingly popular, more and more users are using digital cameras or scanners to digitize various types of images and facilitate the storage of a large quantity of images. In addition, users can also transmit files or download files via network, so that they can share digital images with their friends and family without being limited by their distance apart, and such application is much more convenient than those of the photos or pictures of traditional media.

People usually place traditional photos into photo frames or hang photo frames onto a wall as decorations. To provide the equivalent effect to digital images, a digital photo frame is introduced, and the digital photo frame is connected to a memory card or an electronic apparatus such as a computer, a scanner or a digital camera that stores or provides a digital image file in order to read and display digital image data, so as to eliminate the burden of printing the images.

In addition to the function of displaying digital images, most users also want to input a data pattern, such as the shooting time and place of the photos or a memorial text pattern, to the digital photo frame for displaying the data pattern together with the digital images. To input a text data to a conventional digital photo frame, users must connect the digital photo frame to a personal computer (PC) first and then edit the digital image through the personal computer, and such application is still inconvenient.

In view of the drawbacks of the prior art, the inventor of the present invention based on years of experience in the related industry to conduct extensive researches and experiments, and finally developed digital photo frame apparatus in accordance with the present invention to overcome the aforementioned drawbacks.

### SUMMARY OF THE INVENTION

Therefore, it is a primary objective of the present invention to provide a digital photo frame apparatus to improve the convenience of inputting text data or graphic data to the digital photo frame apparatus.

To achieve the foregoing objective, the present invention provides a digital photo frame apparatus, comprising at least one memory card slot, at least one transmission interface port, a power supply device, a signal processing controller, a display device, a display driver module and an input control module. The power supply device is for supplying a power source. The memory card slot is for connecting a memory card to read a digital image data stored in the memory card. The transmission interface port is for connecting an input device or an electronic apparatus that can store or provide a digital image data. The signal processing controller is for processing the inputted digital image data, and controlling its playback way. The display device is for displaying a digital image, and the display driver module is for driving the display device to display the digital image data processed by the signal processing controller. The input control module is for controlling the input device which is connected to the transmission interface port, so that users can perform a data input operation through the input device.

The input device at least comprises a keyboard, a touch panel, a mouse and a microphone, and the display device at least comprises a cathode ray tube (CRT) screen, a liquid crystal display (LCD), an OLED display, a plasma display panel (PDP). The memory card slot supports a memory card specification comprising a smart digital card (SD card), a compact flash card (CF card), a memory stick (MS card), a smart media card (SM card) or a multi-media card (MM card). The interface supported by the transmission interface port at least comprises a RS232 interface, a USB interface, a USB OTG interface, an IEEE1394 interface or a PCMCIA interface. The electronic apparatus comprise s a personal computer, a digital camera, a digital camcorder, a scanner, a VCD/DVD player and a detachable hard disk.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a block diagram of a digital photo frame apparatus in accordance with the present invention; and

FIG. 2 is a block diagram of a digital photo frame apparatus in accordance with a preferred embodiment of the present invention.

### DETAILED DESCRIPTION OF THE PREFERRED EMBODIMENTS

In the related figures of preferred embodiments of a digital photo frame apparatus of the present invention, the same referring numerals are used for the same components in accordance with the present invention.

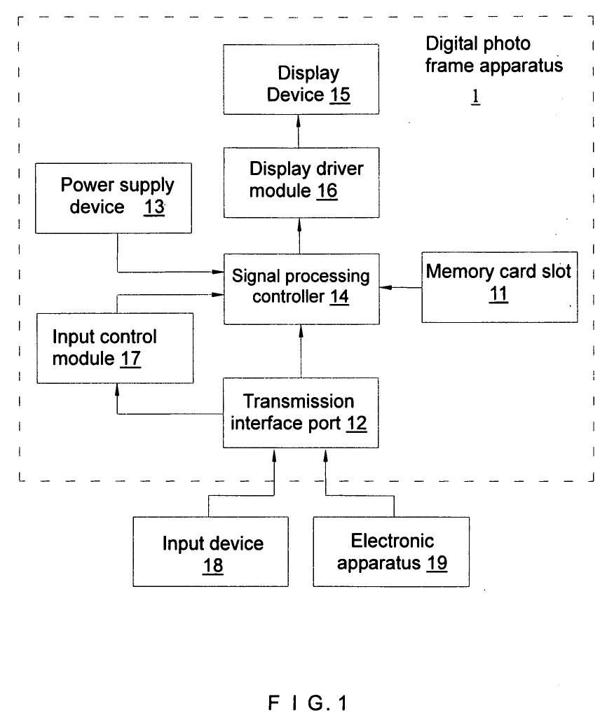

Referring to FIG. 1 for a block diagram of a digital photo frame apparatus in accordance with the present invention, the digital photo frame apparatus 1 comprises at least one memory card slot 11, at least one transmission interface port 12, a power supply device 13, a signal processing controller 14, a display device 15, a display driver module 16 and an input control module 17. The power supply device 13 is for providing a power source, and the memory card slot 11 is for connecting a memory card to read a digital image data stored in the memory card. The memory card slot supports the current common memory card specifications comprising a smart digital card (SD card), a compact flash card (CF card), a memory stick (MS card), a smart media card (SM card) or a multi-media card (MM card).

The transmission interface port 12 is for connecting an input device, such as a keyboard, a touch panel, a mouse a microphone, or an electronic apparatus that stores and provides a digital image data, wherein the interfaces supported by the transmission interface port 12 at least comprise a computer image transmission line interface, an AV terminal, an RS232 interface, an USB interface, an USB OTG interface, an IEEE1394 interface and a PCMCIA interface. The computer image transmission interface, the AV terminal interface and a RS232 interface are generally used for connecting a personal computer or a video recorder, and the USB interface, USB OTG interface, IEEE1394 interface and PCMCIA interface are generally connected to a personal computer, a digital camera, a digital camcorder, a scanner, or an external hard disk, etc.

The signal processing controller 14 is for processing an inputted digital image data, and identifying whether or not the inputted digital image data is in a displayable file format, such as a BMP file, a GIF file, a JPG file, a PNG file or a TIF file, or an animation movie format, such as an MPEG file, an AVI file, a WMV file or an ASF file. After identification, the signal processing controller 14 processes the files according to the types of various different file formats, and converts the inputted digital image data into signals that can be processed by the display driver module 16 before the digital image data is displayed on the display device 15. The signal processing controller 14 can control the playback way of the digital image data. For example, if the signal processing controller 14 identifies that the number of files in a data source device is more than one, then the display driver module 16 will dynamically switch the displaying images based on a predetermined time interval, for example, the displaying digital image file is replaced by another selected digital image file once every half an hour. The display device 15 at least comprises a cathode ray tube (CRT) screen, liquid crystal display (LCD), an OLED display or a plasma display panel (PDP).

The invention is characterized in that the digital photo frame apparatus comprises an input control module, such as an input control module 17 in the digital photo frame apparatus 1 is electrically connected to a signal processing controller 14, for controlling an input device which is connected to the transmission interface port 12. The input device, such as a keyboard, a touch panel, a mouse or a microphone enables a user to perform a data input operation to a digital image. The data input operation at least comprises a operation of inputting a text data or graphic data which is desired to be displayed on a digital image, such as being displayed by an on screen display (OSD) form, or a operation of modifying a digital image directly by adding the inputted text data or graphic data to the digital image, or a operation of recording a section of audio data and then broadcasting the audio data by an audio output module of the digital photo frame apparatus. The input control module 17 can be a keyboard controller, a mouse controller, a touch panel controller or a microphone controller. By the method mentioned above, the user can display a message, such as the shooting time, the shooting place of the photos, a memorial text or message informations, on a digital image which is displayed by a digital photo frame apparatus 1, so as to make the digital photo frame apparatus 1 have a personalized feature.

Besides, the digital photo frame apparatus in accordance with the present invention further comprises a trigger key if needed, so that when a user presses the trigger key, the text data and graphic data inputted by the user or the audio data recorded by the user is displayed on the digital image. The trigger key can be installed at the digital photo frame apparatus or at a remote controller that can operates the digital photo frame apparatus.

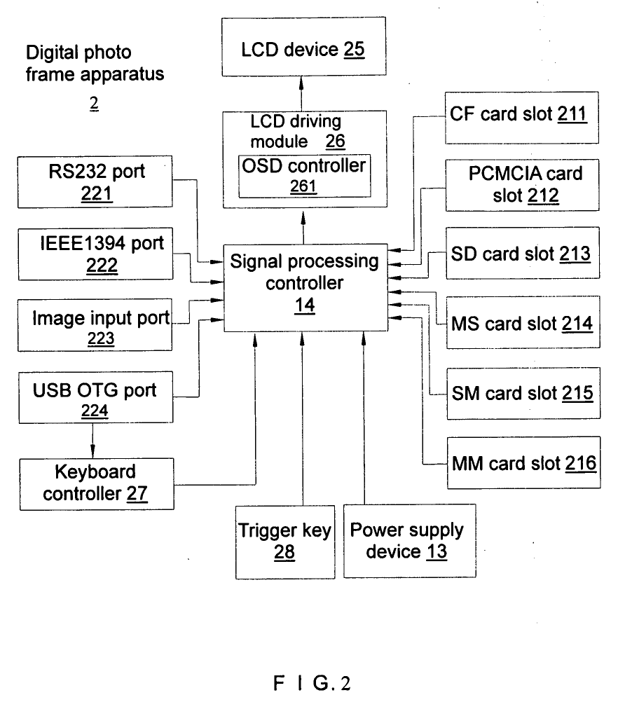

Referring to FIG. 2 for preferred embodiment of a digital photo frame apparatus in accordance with the present invention, the digital photo frame apparatus 2 comprises a plurality of memory card slots 211˜216, a plurality of ports 221˜224, a power supply device 13, a signal processing controller 14, a liquid crystal display device 25, a liquid crystal driving module 26, a keyboard controller 27 and a trigger key 28. The liquid crystal driving module 26 has an OSD controller. Users can insert a memory card containing a digital image into an appropriate memory card slot (one of the memory card slots 211˜216), and the signal processing controller 14 can identify the format of the file stored in the memory card and process the digital image file to convert the digital image into a signal that can be processed by the liquid crystal driving module 26 before the digital image is displayed on the liquid crystal display device 25.

In addition, users also can connect an electronic apparatus containing a digital image to an appropriate port (one of the ports 221˜224), and the signal processing controller 14 accesses a digital image file from the electronic apparatus and processes the digital image file and converts the digital image file into a signal that can be processed by a liquid crystal driving module 26 before the digital image is displayed on the liquid crystal display device 25.

If a user wants to add text onto a digital image displayed on the liquid crystal display device 25, the user can connect a keyboard to a USB OTG port 224, and the keyboard controller 27 can receive the text signal generated by the keyboard, and then the text signal is sent to the signal processing controller 14. The text entered by the user can be displayed onto the liquid crystal display device in an OSD form by the OSD controller 261. In addition, the digital photo frame apparatus 2 can further be installed a mouse controller or a touch panel controller if needed, so that users can use the mouse or touch panel to enter graphics to a digital image. The OSD of the text or graphic can be shown dynamically in a marquee mode. The text data or graphic data can be displayed continuously on the liquid crystal display device 25, or displayed after a user presses the trigger key, and then disappeared after a predetermined time.

The digital photo frame apparatus 2 further comprises a microphone controller if needed, so that a user can record a message audio, and broadcast the recorded audio after the user presses the trigger key.

Since the digital photo frame apparatus of the present invention allows users to enter external data or graphic data directly from a keyboard or a mouse, or allows users to record audio data through a microphone, the present invention greatly enhances the convenience of its application by replacing the necessity of a personal computer.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A digital photo frame apparatus, comprising:
at least one memory card slot, for connecting a memory card to read a digital image data in said memory card;
at least one transmission interface port, for connecting an input device or an electronic apparatus that stores or provides a digital image data;
a power supply device, for supplying a power source;
a signal processing controller, for processing said inputted digital image data, and controlling a playback way of said digital image data;
a display device, for displaying a digital image;
a display driver module, for driving said display device to display said digital image data processed by said signal processing controller; and
an input control module, electrically connected to said signal processing controller, for controlling said input device which is connected to said transmission interface port, such that a user can perform a data input operation by using said input device

2. The digital photo frame apparatus of claim 1, wherein said input device at least comprises a keyboard, a touch panel, a mouse or a microphone.

3. The digital photo frame apparatus of claim 1, wherein said input control module at least comprises a keyboard controller, a touch panel controller, a mouse controller or a microphone controller.

4. The digital photo frame apparatus of claim 1, wherein said display device comprises a cathode ray tube (CRT) screen, a liquid crystal display (Liquid Crystal Display, LCD), an OLED display or a plasma display panel (PDP).

5. The digital photo frame apparatus of claim 1, wherein said memory card slot supports a memory card specification comprising a smart digital card (SD card), a compact flash card (CF card), a memory stick (MS card), a smart media card (SM card) or a multi-media card (MM card).

6. The digital photo frame apparatus of claim 1, wherein said transmission interface port supports the interface at least comprising a RS232 interface, a USB2.0 interface, a USB OTG interface, an IEEE1394 interface or a PCMCIA interface.

7. The digital photo frame apparatus of claim 1, wherein said transmission interface port supports an interface comprising a computer image transmission line interface or an AV terminal.

8. The digital photo frame apparatus of claim 1, wherein said signal processing controller has a function of dynamically switching digital images.

9. The digital photo frame apparatus of claim 1, wherein said display driver module comprises an OSD controller.

10. The digital photo frame apparatus of claim 1, wherein said data input operation comprises an operation of displaying a text data or a graphic data inputted by said user through said input device with said digital image in an OSD form.

11. The digital photo frame apparatus of claim 10, further comprising a trigger key, wherein when said trigger key is pressed, said text data or said graphic data is displayed on said digital image and disappeared after a predetermined time.

12. The digital photo frame apparatus of claim 10, wherein said text data or said graphic data is displayed by a marquee mode.

13. The digital photo frame apparatus of claim 1, wherein said data input operation comprises an operation of recording an audio data through said input device by a user.

14. The digital photo frame apparatus of claim 13, further comprising a trigger key, wherein when said trigger key is pressed, said audio data is broadcasted.
